(19) United States
(12) Patent Application Publication
(10) Pub. No.: US 2007/0110121 A1
(43) Pub. Date: May 17, 2007

(54) Temperature sensing apparatus with flexible contact

(75) Inventor: Hul-Chun Hsu, Taichung City (TW)

Correspondence Address: HDSL, 4331 STEVENS BATTLE LANE, FAIRFAX, VA, 22033, US

(73) Assignee: JAFFE LIMITED

(21) Appl. No.: 11/271,873

(22) Filed: Nov. 14, 2005

(51) Int. Cl. G01K 1/14; G01K 1/00

(52) U.S. Cl. 374/147; 374/208

(57) ABSTRACT

A temperature sensing apparatus with flexible contact includes a rod-shaped body, a temperature-sensing head elastically arranged at one end of the body and a clamping rod transversely locked to the body. The temperature-sensing head is connected to a temperature-sensing wire. Another end of the clamping rod is defined with a locking section such that the clamping rod can be connected to a heat-pipe temperature sensing apparatus. Both straight heat pipe and curved heat pipe can be examined by the temperature sensing apparatus with flexible contact.

### BACKGROUND OF THE INVENTION

1. Field of the Invention

The present invention relates to a temperature sensing apparatus with flexible contact, especially to a temperature sensing apparatus used to examine straight heat pipes and curved heat pipes.

2. Description of Prior Art

The conventional heat pipe needs examination for heat conduction amount after a batch of heat pipes are manufactured. However, the conventional examination instruments or equipments are expensive and the operation thereof is cumbersome and time consuming. Therefore, the examination of heat pipe is conducted in sampling fashion instead of entire examination. Certain amount of heat pipes are sampled for inspection to estimate the yield for one batch.

However, all of the heat pipes are not straight pipe during examination. Some of them might be curved pipe for specific applications.

### SUMMARY OF THE INVENTION

The present invention is to provide a temperature sensing apparatus with flexible contact for heat pipe, which can be used for both straight heat pipes and curved heat pipes.

Accordingly, the present invention provides a temperature sensing apparatus with flexible contact. The temperature sensing apparatus comprises a rod-shaped body, a temperature-sensing head elastically arranged at one end of the body and a clamping rod transversely locked to the body. The temperature-sensing head is connected to a temperature-sensing wire. Another end of the clamping rod is defined with a locking section such that the clamping rod can be connected to a heat-pipe temperature sensing apparatus. Both straight heat pipe and curved heat pipe can be examined by the temperature sensing apparatus with flexible contact.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a sectional view of the temperature sensing apparatus for heat pipe according to the present invention.

FIG. 2 shows a partial sectional view of the temperature sensing apparatus for heat pipe according to the present invention.

FIG. 3 shows a partial top view of the temperature sensing apparatus for heat pipe according to the present invention.

FIG. 4 shows another partial top view of the temperature sensing apparatus for heat pipe according to the present invention.

### DETAILED DESCRIPTION OF THE INVENTION

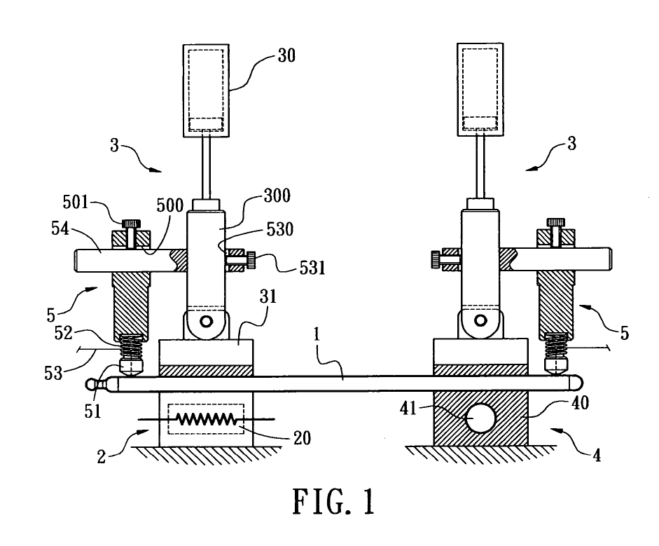

FIG. 1 shows a sectional view of the temperature sensing apparatus for heat pipe according to the present invention. The present invention provides a temperature sensing apparatus with flexible contact for the examination of heat pipes. The temperature sensing apparatus comprises a heating unit 2, two clamping units 3 and a cooling circulation system 4. The heating unit 2 comprises a heater 20 to control heating amount and temperature rising speed and is located at one end of the heat pipe 1. The cooling circulation system 4 is arranged at another side of the heat pipe 1 and comprises a cooling block 40 and at least one cooling conduit 41 through the cooling block 40. The cooling conduit 41 is used to connect to another cooling water supplying system (not shown), which is functioned to supply continuously cooling water to the cooling conduit 41. The two clamping units 3 are used to clamp both ends of the heat pipe 1 and each comprises a pushing unit 30 and a clamping block 31 driven by the pushing unit 30. The pushing unit 30 comprises a pushing arm 300 and the clamping block 31 is pivotally arranged on the pushing am 300 to provide clamping force to both ends of the heat pipes 1.

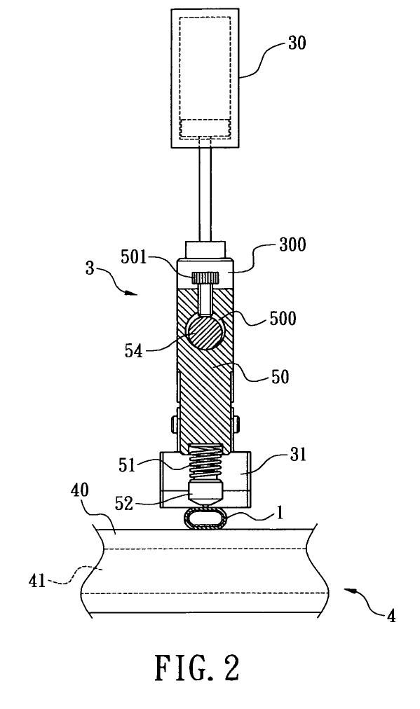

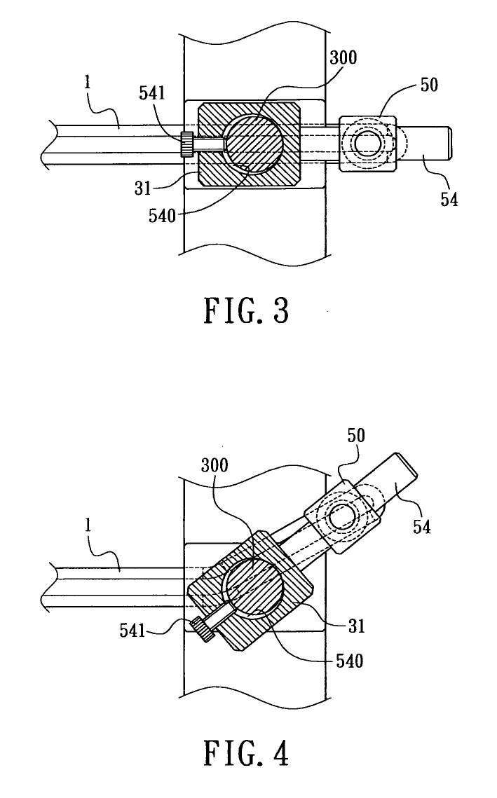

With reference to FIGS. 2 and 3, the present invention provides a temperature sensing apparatus 5 with flexible contact and arranged on the heat-pipe temperature sensing apparatus. The temperature sensing apparatus 5 with flexible contact comprises a body 50, a temperature-sensing head 51 elastically arranged at end of the body 50 and a clamping rod 54 transversely locked to the body 50.

The body 50 is of rod-shaped and provides a supporting structure. The body 50 comprises a transverse hole 500 and one end of the clamping rod 54 is inserted into the transverse hole 500 such that the body has lateral movement. A bolt 501 is used to lock the clamping rod 54. Another end of the clamping rod 54 is defined with a locking section, which is a through hole 540. The pushing unit 30 of the clamping unit 3 has lateral movement in the through hole 540 and is clamped by a bolt 541. The temperature-sensing head 51 is made of thermal-isolation material such as plastics or bakelite and is connected to a temperature sensing wire 53. The temperature sensing wire 53 can be fixed to the temperature-sensing head 51 by glue. A spring element 52 is connected between the temperature-sensing head 51 and an end of the body 50, where the spring element 52 can be compression spring, plate spring or torque spring and provides spring contact force when the temperature-sensing head 51 is in contact with the heat pipe 1.

FIG. 3 shows a schematic diagram of examining a straight heat pipe. The clamping rod 54 is placed at a position overlapping with the heat pipe 1 and the body 50 is laterally moved to atop the heat pipe 1 to be examined. The body 50 and the clamping rod 54 are locked with bolts 501 and 541. Therefore, the temperature-sensing head 51 at end of the body 50 can perform temperature-sensing operation for the straight heat pipe 1.

FIG. 4 shows a schematic diagram of examining a curved heat pipe. The clamping rod 54 is rotatable atop the pushing unit 30 of the clamping unit 3 for use with the curved heat pipe 1. The clamping rod 54 moves the body 50 to a position atop the heat pipe 1 to be examined. The body 50 can be adjusted the position again. Therefore, the temperature-sensing head 51 is aligned with the temperature-sensing point. The body 50 and the clamping rod 54 are again locked with bolts 501 and 541. Therefore, the temperature sensing apparatus 5 with spring contact can perform temperature-sensing operation for the curved heat pipe 1.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A temperature sensing apparatus with flexible contact, comprising
a body providing a supporting structure; and
a temperature-sensing head elastically arranged at one end of the body and connected to a temperature-sensing wire.

2. The temperature sensing apparatus with flexible contact as in claim 1, further comprising a clamping rod, wherein the body is defined with a transverse hole and one end of the clamping rod passes the transverse hole to be fixed by a bolt.

3. The temperature sensing apparatus with flexible contact as in claim 1, wherein the temperature-sensing head and the end of the body is connected with a spring element.

4. The temperature sensing apparatus with flexible contact as in claim 3, wherein the spring element is a compression spring, a plate spring or a torque spring.

5. The temperature sensing apparatus with flexible contact as in claim 1, wherein the temperature-sensing head is made of thermal-isolation material.

6. The temperature sensing apparatus with flexible contact as in claim 5, wherein the thermal-isolation material is plastics or bakelite.

7. The temperature sensing apparatus with flexible contact as in claim 1, wherein the temperature-sensing wire is fixed to the temperature-sensing head by glue.

8. The temperature sensing apparatus with flexible contact as in claim 1, further comprising a clamping rod transversely locked to the body and another end of the clamping rod is defined with a locking section.

9. The temperature sensing apparatus with flexible contact as in claim 8, wherein the locking section is a through hole.
